(19) United States
(12) Patent Application Publication
(10) Pub. No.: US 2017/0093969 A1
(43) Pub. Date: Mar. 30, 2017

(54) INFORMATION PROCESSING DEVICE, INFORMATION PROCESSING SYSTEM, INFORMATION PROCESSING METHOD AND PROGRAM

(71) Applicant: SONY CORPORATION, TOKYO (JP)

(72) Inventor: SHINJI OHTA, KANAGAWA (JP)

(21) Appl. No.: 15/311,580

(22) PCT Filed: Feb. 24, 2015
(86) PCT No.: PCT/JP2015/055181

§ 371 Date: Nov. 16, 2016

(30) Foreign Application Priority Data
May 27, 2014 (JP) 2014-108650

(51) Int. Cl. H04L 29/08

(52) U.S. Cl. CPC H04L 67/1074; H04L 67/1095

(57) ABSTRACT

An object is to readily share personal contents with other users. An information processing device includes a web server and a control unit. The web server is configured to provide a content transmission environment to one or more other information processing devices connected using radio communication. The web server is also configured to acquire a content transmitted from any of the other information processing devices where the content transmission environment has been set (a content relating to a user possessing the other information processing device). In addition, the control unit is configured to display a content acquired by the web server.

### CROSS REFERENCE TO RELATED APPLICATIONS

This application is a U.S. National Phase of International Patent Application No. PCT/JP2015/055181 filed on Feb. 24, 2015, which claims priority benefit of Japanese Patent Application No. JP 2014-108650 filed in the Japan Patent Office on May 27, 2014. Each of the above-referenced applications is hereby incorporated herein by reference in its entirety.

### TECHNICAL FIELD

The present technology relates to an information processing device. Specifically, the present technology relates to an information processing device that deals with contents, an information processing system, and information processing method therefor, and a program for causing a computer execute the method.

### BACKGROUND ART

Conventionally, information processing devices dealing with various contents have been proposed. For example, a projector capable of projecting images onto a screen to display the images on the screen has been proposed (refer, for example, to Patent Document 1).

### CITATION LIST

### Patent Document

Patent Document 1: Japanese Patent Application Laid-Open No. H06-141257

### SUMMARY OF THE INVENTION

### Problems to be Solved by the Invention

With the conventional technology mentioned above, images based on various contents can be projected onto a screen, and the images can thus be displayed on the screen.

Note that information processing devices such as smart phones and tablet terminals are widely used in recent years. In addition, users can create various contents (still image contents, video contents, for example) by using such information processing devices.

The information processing devices are expected to be further utilized if an environment in which personal contents created in this manner can be readily shared with other users can be provided.

The present technology has been produced in view of these circumstances, and an object thereof is to allow personal contents to be readily shared with other users.

### Solutions to Problems

The present technology has been achieved to solve the aforementioned problems, and a first aspect thereof is an information processing device including: a web server configured to provide a content transmission environment to one or more other information processing devices connected using radio communication, and acquire a content transmitted from any of the other information processing devices where the content transmission environment has been set, the content relating to a user possessing the other information processing device; and a control unit configured to display the acquired content, an information processing method therefor, and a program for causing a computer to execute the method. This produces an effect of providing a content transmission environment to one or more other information processing devices connected using radio communication, acquiring a content transmitted from any of the other information processing devices where the content transmission environment has been set (the content relating to a user possessing the other information processing device), and displaying the acquired content.

Furthermore, in the first aspect, in response to a transmission request from the one or more other information processing devices, the web server may provide the displayed content to the other information processing device or devices. This produces an effect of providing a displayed content to one or more other information processing devices in response to a transmission request from the other information processing device or devices.

Furthermore, in the first aspect, the web server may refrain from providing a content having restriction information added thereto among the displayed content to the other information processing device or devices having transmitted the transmission request. This produces an effect of refraining from providing a content having restriction information added thereto among the displayed content to the other information processing device or devices having transmitted the transmission request.

Furthermore, in the first aspect, the control unit may determine whether or not to restrict provision of the displayed content to the other information processing device or devices having transmitted the transmission request, and the web server may refrain from providing a content, provision of which to the other information processing device or devices having transmitted the transmission request is determined to be restricted, to the other information processing device or devices. This produces an effect of refraining from providing a content, provision of which to the other information processing device or devices having transmitted the transmission request is determined to be restricted, to the other information processing device or devices.

Furthermore, in the first aspect, in response to a request from any of the other information processing devices, the web server may provide the content transmission environment to the other information processing device. This produces an effect of providing a content transmission environment to other information processing devices in response to a request from the other information processing devices.

Furthermore, in the first aspect, a projection unit configured to project and display an image based on the acquired content onto a projection plane may further be included, wherein the control unit may display the acquired content by projection onto the projection plane by the projection unit. This produces an effect of displaying an acquired content by projection onto the projection plane by the projection unit.

Furthermore, in the first aspect, a display unit configured to display an image based on the acquired content may further be included, wherein the control unit may cause the display unit to display the image based on the acquired content. This produces an effect of causing the display unit to display an acquired content.

Furthermore, in the first aspect, the control unit may perform control relating to the displayed content in response to an operation request from other information processing device or devices where the content transmission environment has been set. This produces an effect of performing control relating to the displayed content in response to an operation request from other information processing device or devices where the content transmission environment has been set.

Furthermore, a second aspect of the present technology is an information processing system including: a first information processing device configured to transmit a setting request to a second information processing device by using radio communication, the setting request being for setting a content transmission environment for transmitting a content relating to a user possessing the first information processing device by using radio communication; and the second information processing device including a web server configured to provide the content transmission environment to the first information processing device, and acquire a content transmitted from the first information processing device where the content transmission environment has been set, the content relating to a user possessing the first information processing device, and a control unit configured to display the acquired content, and an information processing method therefor, and a program causing a computer to execute the method. This produces an effect in which a first information processing device transmits a setting request to a second information processing device by using radio communication, the setting request being for setting a content transmission environment for transmitting a content relating to a user possessing the first information processing device by using radio communication; and the second information processing device provides the content transmission environment to the first information processing device, acquires a content transmitted from the first information processing device where the content transmission environment has been set (the content relating to a user possessing the first information processing device), and displays the acquired content.

### Effects of the Invention

According to the present technology, an excellent effect of allowing personal contents to be readily shared with other users can be produced. Note that the effects stated here are not limited to those stated here but may include any effect mentioned in the present disclosure.

### BRIEF DESCRIPTION OF DRAWINGS

FIG. 1 is a diagram illustrating an example use of an information processing system 100 in an embodiment of the present technology.

FIG. 2 is a block diagram illustrating an example internal configuration of an information processing device 200 in an embodiment of the present technology.

FIG. 3 is a diagram illustrating an example transition of a projected image projected and displayed by the information processing device 200 in an embodiment of the present technology.

FIG. 4 is a diagram illustrating an example transition of an image displayed on a touch panel 301 of an information processing device 300 in an embodiment of the present technology.

FIG. 5 is a diagram illustrating an example transition of a projected image projected and displayed by the information processing device 200 in an embodiment of the present technology.

FIG. 6 is a diagram illustrating an example transition of a projected image projected and displayed by the information processing device 200 in an embodiment of the present technology.

FIG. 7 is a diagram illustrating an example transition of a projected image projected and displayed by the information processing device 200 in an embodiment of the present technology.

FIG. 8 is a diagram illustrating an example transition of an image displayed on the touch panel 301 of the information processing device 300 in an embodiment of the present technology.

FIG. 9 is a diagram illustrating an example transition of a projected image projected and displayed by the information processing device 200 in an embodiment of the present technology.

FIG. 10 is a sequence chart illustrating example communication processing between devices included in the information processing system 100 in an embodiment of the present technology.

FIG. 11 is a sequence chart illustrating example communication processing between devices included in the information processing system 100 in an embodiment of the present technology.

FIG. 12 is a sequence chart illustrating example communication processing between devices included in the information processing system 100 in an embodiment of the present technology image.

FIG. 13 is a sequence chart illustrating example communication processing between devices included in the information processing system 100 in an embodiment of the present technology.

### MODE FOR CARRYING OUT THE INVENTION

Modes (hereinafter referred to as embodiments) for carrying out the present technology will be described below. Note that the description will be made in the following order.

1. Embodiment (example of readily sharing personal contents with other users)

### 1. Embodiment

### Example Use of Information Processing System

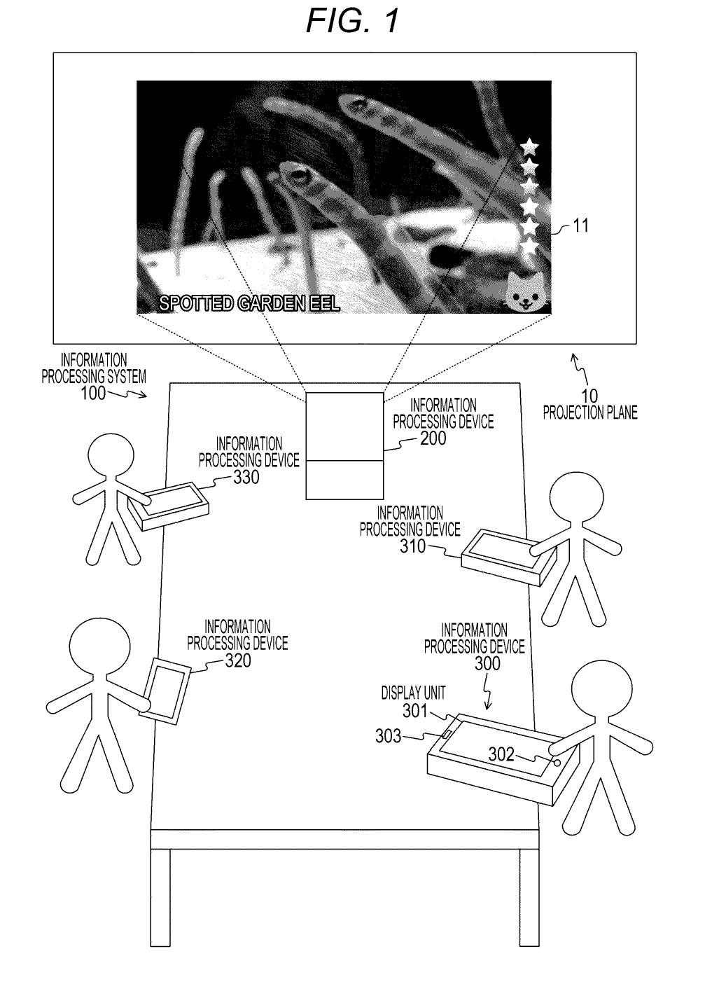

FIG. 1 is a diagram illustrating an example use of an information processing system 100 in an embodiment of the present technology.

The information processing system 100 includes an information processing device 200, an information processing device 300, an information processing device 310, an information processing device 320, and an information processing device 330. Note that, in the embodiment of the present technology, an example in which the information processing device 200 functions as a server while the information processing device 300, the information processing device 310, the information processing device 320, and the information processing device 330 each function as a client will be presented.

The information processing system 100 is used at a meeting such as a conference, for example, in such a manner that the information processing device 200, the information processing device 300, the information processing device 310, the information processing device 320, and the information processing device 330 are connected with one another using radio communication. For example, one of users having the information processing device 300, the information processing device 310, the information processing device 320, or the information processing device 330 in their hands is a speaker, and the information treatment device that the speaker has and the information processing device 200 are connected to each other. The speaker can then give a presentation while displaying an image 11 on a projection plane 10.

Note that, in FIG. 1, a surface of a planar shape (or a non-planar shape) such as a screen, a wall, or a ceiling on which images can be displayed is schematically illustrated as the projection plane 10. Note that images mentioned in the embodiment of the present technology also include the meaning of video.

In addition, in the embodiment of the present technology, an example of the information processing device 200 that is placed on a table and projects images onto the projection plane 10 as illustrated in FIG. 1 will be described. For example, the information processing device 200 can be a portable information processing device.

In addition, the information processing device 200 is an image projector (such as a network-enabled projector, or a content display device) having a radio communication function and being configured to project an image onto the projection plane (projection screen surface) 10 to display an image 11 on the projection plane 10.

The information processing device 300, the information processing device 310, the information processing device 320, and the information processing device 330 are portable information processing devices having a radio communication function, for example. Herein, portable information processing devices include information processing devices such as smart phones, mobile phones, tablet terminals, personal computers (PCs), game devices, and household electrical appliances, for example. In addition, the respective users can perform various operations on the information processing device 300, the information processing device 310, the information processing device 320, or the information processing device 330 held in their hands.

For example, the information processing device 200, the information processing device 300, the information processing device 310, the information processing device 320, and the information processing device 330 are each capable of carrying out radio communication with each other using a wireless local area network (LAN) communication scheme. The wireless LAN communication scheme is a communication scheme based on the IEEE (Institute of Electrical and Electronic Engineers) 802.11 standard, for example. For example, Wi-Fi (registered trademark) (Wireless Fidelity) can be used.

Alternatively, for the communication scheme of communication between the information processing devices, a communication scheme, other than connection via a wireless LAN, capable of establishing internet protocol (IP) communications with other information processing devices may be used. Thus, any communication scheme, which corresponds to an underlying layer of IP communications, may be used as long as IP communications can be established.

Examples of other radio communication standards that can be used include 3rd Generation (3G) (International Mobile Telecommunication (IMT)-2000), and Long Term Evolution (LTE). Furthermore, examples of other radio communication standards include Worldwide Interoperability for Microwave Access (WiMAX) (IEEE802.16e), and 4th Generation (4G) (IMT-Advanced).

[Example Configuration of Information Processing Device]

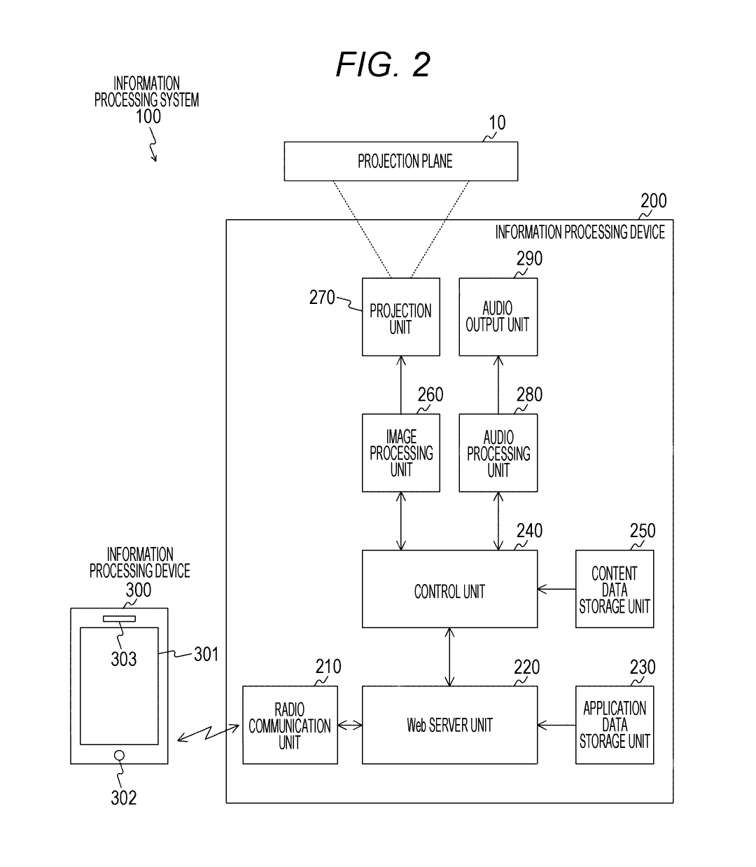

FIG. 2 is a block diagram illustrating an example internal configuration of the information processing device 200 in the embodiment of the present technology. FIG. 2 also illustrates the information processing device 300 in addition to the example internal configuration of the information processing device 200. Note that the relations between the information processing device 200 and the other information processing devices (the information processing devices 310, 320, and 330) are similar to that between the information processing device 200 and the information processing device 300. Thus, only the information processing device 300 is illustrated here while the other information processing devices are not illustrated and the description thereof will not be provided.

The information processing device 200 includes a radio communication unit 210, a web server unit 220, an application data storage unit 230, a control unit 240, a content data storage unit 250, an image processing unit 260, a projection unit 270, an audio processing unit 280, and an audio output unit 290. Note that the projection plane 10 is a projection plane (a screen of a projector module or the like, for example) on which images projected from the projection unit 270 are reflected.

The radio communication unit 210 is configured to transmit and receive information (such as control data and image data) to/from other information processing devices (the information processing device 300, for example) using radio communication on the basis of control performed by the web server unit 220.

In addition, a plurality of radio communication schemes can be used. For example, during initiation of radio communication, only transmission and reception of data (such as service set identifier (SSID), for example) relating to power on and Wi-Fi are performed by near field communication (NFC). Then, transmission and reception of subsequent data can be performed by Wi-Fi.

Furthermore, for redirection by a domain name system (DNS), the need for entering a uniform resource locator (URL) can be substantially eliminated.

In addition, for connection by Wi-Fi Direct, since operation is achieved only by starting of a web browser, the need for entering an URL can be eliminated.

The web server unit 220 is configured to provide one or more other information processing devices connected using radio communication with a content transmission environment (a web application (web app), for example). In this case, for example, the web server unit 220 provides another information processing device with the content transmission environment in response to a request from this another information processing device. For example, the web server unit 220 reads application data (data of a web application, for example) stored in the application data storage unit 230, and provides another information processing device with the read data.

The web server unit 220 also acquires a content transmitted from another information processing device where the content transmission environment has been set (a content relating to the user of this another information processing device). The web server unit 220 then stores the acquired content in the content data storage unit 250 via the control unit 240.

For example, in response to a transmission request from one or more other information processing devices, the web server unit 220 provides these other information processing devices with contents projected by the projection unit 270 and displayed on the projection plane 10. In this case, the web server unit 220 may refrain from providing the other information processing devices, which transmitted the transmission requests, with a content having restriction information added thereto among the displayed contents. Furthermore, for example, the web server unit 220 may refrain from providing the other information processing devices, which transmitted the transmission requests, with a content provision of which to theses other information processing devices is determined to be restricted by the control unit 240.

The application data storage unit 230 is configured to store application data, and supplies the stored application data to the web server unit 220. Note that application data are data for another information processing device to set a content transmission environment, for example. The content transmission environment is a web application, for example.

The control unit 240 is configured to control respective components of the information processing device 200 on the basis of control programs. For example, the control unit 240 is implemented by a central processing unit (CPU).

For example, the control unit 240 displays contents acquired by the web server unit 220 by projection onto the projection plane 10 by the projection unit 270.

Furthermore, for example, the control unit 240 performs control relating to the displayed contents in response to operation requests from other information processing devices where the content transmission environment is set.

The content data storage unit 250 is configured to store content data, and supplies the stored content data to the control unit 240. Note that the content data are data relating to contents transmitted from other information processing devices, for example. Examples of the content data include still image contents, video contents, and music contents.

Furthermore, contents stored in the content data storage unit 250 are managed with use of management information (serial numbers, for example) assigned to the respective information processing devices and IP addresses assigned to the respective information processing devices. In addition, in a case where images (such as icons or avatars (cat, mouse, and frog, for example) for identifying the respective information processing devices are displayed in association with contents, the images are stored in association with the contents.

The image processing unit 260 is configured to perform a variety of image processing on images (image data) output from the control unit 240 on the basis of the control of the control unit 240, and outputs images subjected to the image processing to the projection unit 270.

The projection unit 270 is an image output device for projecting the images subjected to the image processing performed by the image processing unit 260 for display onto the projection plane 10.

The audio processing unit 280 is configured to perform a variety of audio processing on audio (audio data) output from the control unit 240 on the basis of the control of the control unit 240, and outputs audio subjected to the audio processing to the audio output unit 290.

The audio output unit 290 is an audio output device (a speaker, for example) configured to output audio subjected to audio processing performed by the audio processing unit 280.

The information processing device 300 includes a touch panel 301, an operation receiving unit 302, and an audio output unit 303. For example, the information processing device 300 uses radio communication to transmit, to the information processing device 200, a setting request for setting a content transmission environment for transmitting contents relating to the user by using radio communication. In addition, for example, the information processing device 300 uses radio communication to transmit, to the information processing device 200, contents relating to the user after the content transmission environment is set.

The touch panel 301 is a touch panel for displaying a variety of information on the basis of control performed by a control unit (not illustrated) and with which the user can input operations by touching a display surface thereof with a finger or moving a finger close to the display surface. Note that, for a display panel of the touch panel 301, a display panel such as an organic electroluminescence (EL) panel or a liquid crystal display (LCD) panel can be used.

The operation receiving unit 302 is an operation receiving unit configured to receive operation inputs entered by the user, and outputs operation information associated with the received operation inputs to the control unit (not illustrated).

The audio output unit 303 is an audio output unit (a speaker, for example) configured to output a variety of audio on the basis of control performed by the control unit (not illustrated).

Now, a case where the user possessing the information processing device 300 gives presentation as a speaker using the information processing device 200 will be described.

The information processing device 200 and the information processing device 300 are connected to a network via the radio communication unit 210. In this state, the user starts a general-purpose web browser mounted in the information processing device 300, and accesses the web server unit 220 of the information processing device 200. When the information processing device 200 is accessed in this manner, the control unit 240 of the information processing device 200 returns web application data stored in the application data storage unit 230 to the web browser of the information processing device 300.

Upon receiving the web application data, the control unit (not illustrated) of the information processing device 300 starts a web application (content transmission environment).

Subsequently, the user operates the web application on the information processing device 300 to transmit a content (content data) to be displayed using the information processing device 200 to the information processing device 200. Upon receiving the content, the information processing device 200 stores the received content data into the content data storage unit 250 via the web server unit 220 and the control unit 240. The content stored in the content data storage unit 250 is then subjected to image processing performed by the image processing unit 260 and projected onto the projection plane 10 by the projection unit 270. In addition, when audio data are contained in a content projected by the projection unit 270, audio is output from the audio output unit 290 via the audio processing unit 280.

Note that the embodiment of the present technology is also applicable to an information processing device (a content display device, for example) including a display unit instead of the projection unit 270.

[Example of Display of Projected Image and Example of Display of Display Screen in Information Processing Device]

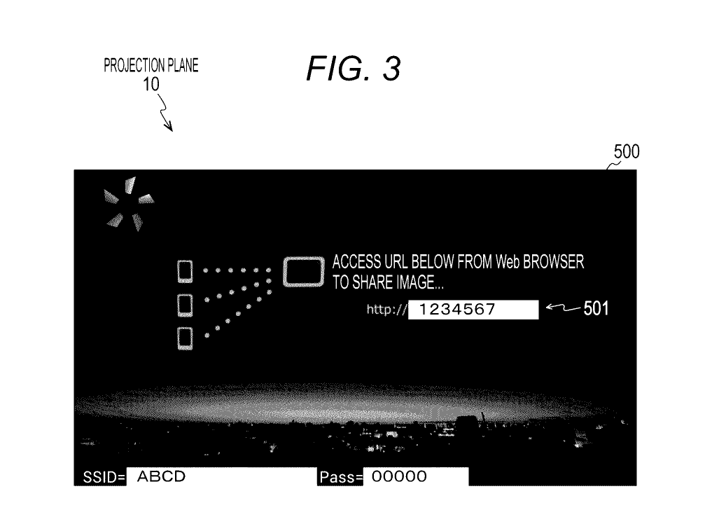

FIGS. 3, 5 to 7, and 9 are diagrams illustrating examples of transition of projected images projected and displayed by the information processing device 200 in the embodiment of the present technology.

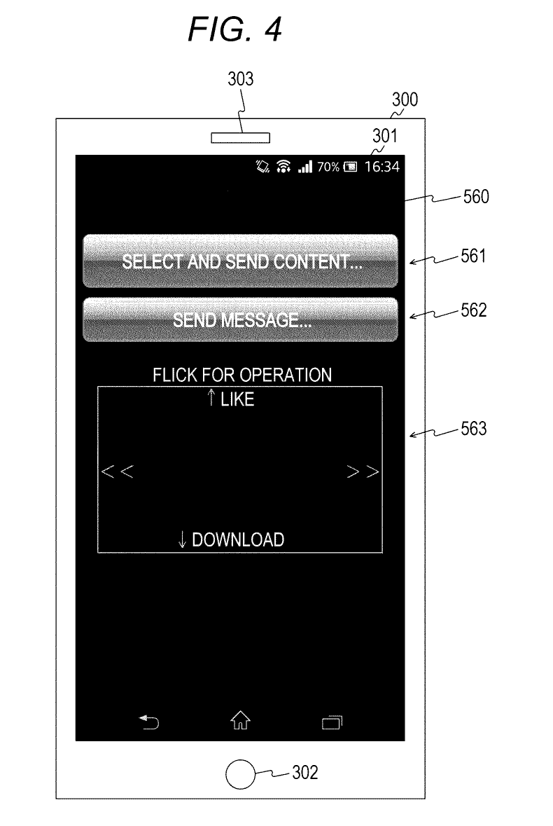

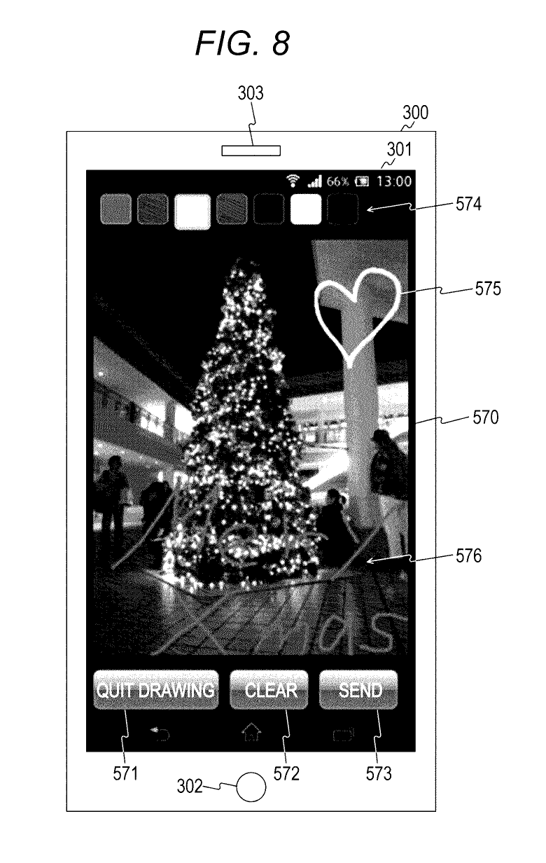

FIGS. 4 and 8 are diagrams illustrating examples of transition of images displayed on the touch panel 301 of the information processing device 300 in the embodiment of the present technology.

FIG. 3 illustrates a projected image 500 projected and displayed by the information processing device 200. The projected image 500 is a screen (initial screen) displayed when the information processing device 300 is connected to the information processing device 200. Note that, in FIG. 3, for simplicity of explanation, only simplified characters are shown for an URL 501, a SSID, Pass (a password), and the like.

For example, for connecting the information processing device 300 to the information processing device 200, the user activates the information processing device 200. For example, the user powers on the information processing device 200. Note that, subsequently, the user need not operate the information processing device 200 itself.

Subsequently, the user uses radio communication to perform operation for connecting the information processing device 300 and the information processing device 200 to a network at the information processing device 300.

Subsequently, the user starts the web browser in the information processing device 300 and enters a predetermined URL. For example, the user manually enters a URL 501 displayed on the projected image 500 illustrated in FIG. 3 while viewing the URL 501. Subsequently, a web application is automatically started on the web browser in the information processing device 300.

FIG. 4 illustrates an operation screen 560 displayed on the touch panel 301 of the information processing device 300.

On the operation screen 560, an operation button 561, an operation button 562, and an operation area 563 for operation of a projected image projected and displayed by the information processing device 200 are displayed.

The operation button 561 is a button to be pressed by a user operation for selecting and sending a content stored in the information processing device 300.

The operation button 562 is a button to be pressed by a user operation for inputting and sending a message to be displayed on the projection plane 10.

The operation area 563 is an area (flick area) for performing various operations by flick operations on a projected image to be displayed on the projection plane 10.

[Example of Content Transmission]

Now, an example of transmission for sending a content from the information processing device 300 to the information processing device 200 will be described.

The user presses the operation button 561 on the operation screen 560. When the operation button 561 is pressed, contents stored in the information processing device 300 are listed on the touch panel 301. The user then performs a selecting operation (an operation of touching an image or images representing a content or contents, for example) of selecting one or more contents to be transmitted to the information processing device 300 and displayed on the projection plane 10 from the contents listed on the touch panel 301. The user then performs a transmitting operation (an operation of touching a send button, for example) for sending the selected content or contents to the information processing device 300. When the transmitting operation has been performed, the content or contents selected by the user is/are transmitted from the information processing device 300 to the information processing device 200. The information processing device 200 then projects and displays the content or contents selected by the user onto the projection plane 10 from the projection unit 270.

Note that, in the operation of transmitting a content, a text (such as a comment or a message) to be displayed with the content to be transmitted can be input. For displaying a text with a content in this manner, the user presses the operation button 562 on the operation screen 560.

When the operation button 562 is pressed, an input screen for inputting a message is displayed on the touch panel 301. The user then performs an inputting operation of inputting a message to be displayed on the projection plane 10 (or a selecting operation of selecting a desired message from a plurality of messages) on the input screen displayed on the touch panel 301. The user then performs a transmitting operation (an operation of touching the send button, for example) for sending the input (selected) message to the information processing device 300. In this manner, the input (selected) message is transmitted form the information processing device 300 to the information processing device 200.

[Example of History Display]

Now, an example of setting a history display mode (an example of displaying a history) from the information processing device 300 will be described.

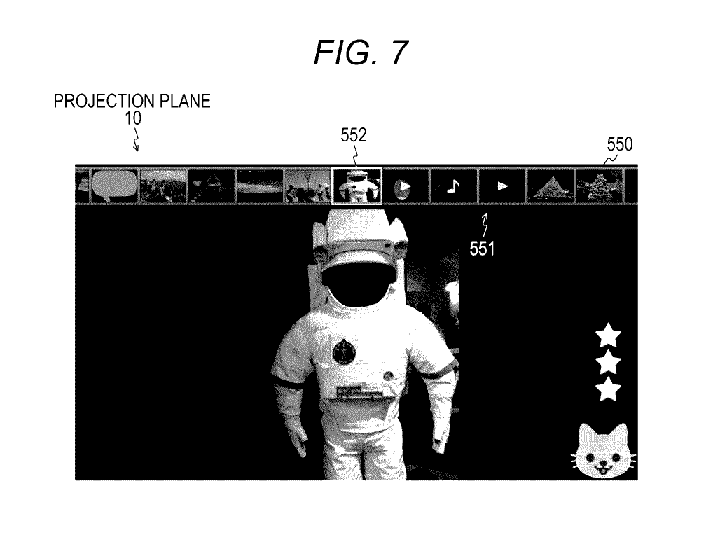

The user performs a flick operation in the lateral direction (either rightward or leftward) on the operation area 563 of the operation screen 560. When the flick operation is performed in the lateral direction on the operation area 563, information of the operation is transmitted from the information processing device 300 to the information processing device 200. Upon receiving the information of the operation, the information processing device 200 sets a history display mode. Thus, the information processing device 200 displays the projected image on the projection plane 10 in the history display mode. For example, a projected image 550 illustrated in FIG. 7 is displayed on the projection plane 10.

In addition, a flick operation in the lateral direction on the operation area 563 of the operation screen 560 enables switching of a main images to be displayed on the projected image 550 with a previous or next image (a previous or next image in a thumbnail image display area 551). Note that an image in a selected state among images in the thumbnail image display area 551 is displayed with a frame 552 indicating the selected state.

[Example of Content Downloading]

Now, an example of downloading a content in a case where a content is downloaded from the information processing device 200 onto the information processing device 300 will be described.

The user performs a downward flick operation in the operation area 563 of the operation screen 560. When the downward flick operation is performed in the operation area 563, a preview image of the main image displayed on the projected image 550 illustrated in FIG. 7 and a dialogue are displayed on the touch panel 301, for example. The dialogue contains a message of “Download?” and an “Yes” button.

The user performs an operation of tapping the “Yes” button in the dialogue. When the tapping operation is performed, downloading of the content whose preview image is displayed on the touch panel 301 is started.

[Example of Content Grading]

Now, an example of grading a content in a case where grading of a content displayed on the projection plane 10 is performed from the information processing device 300 will be described.

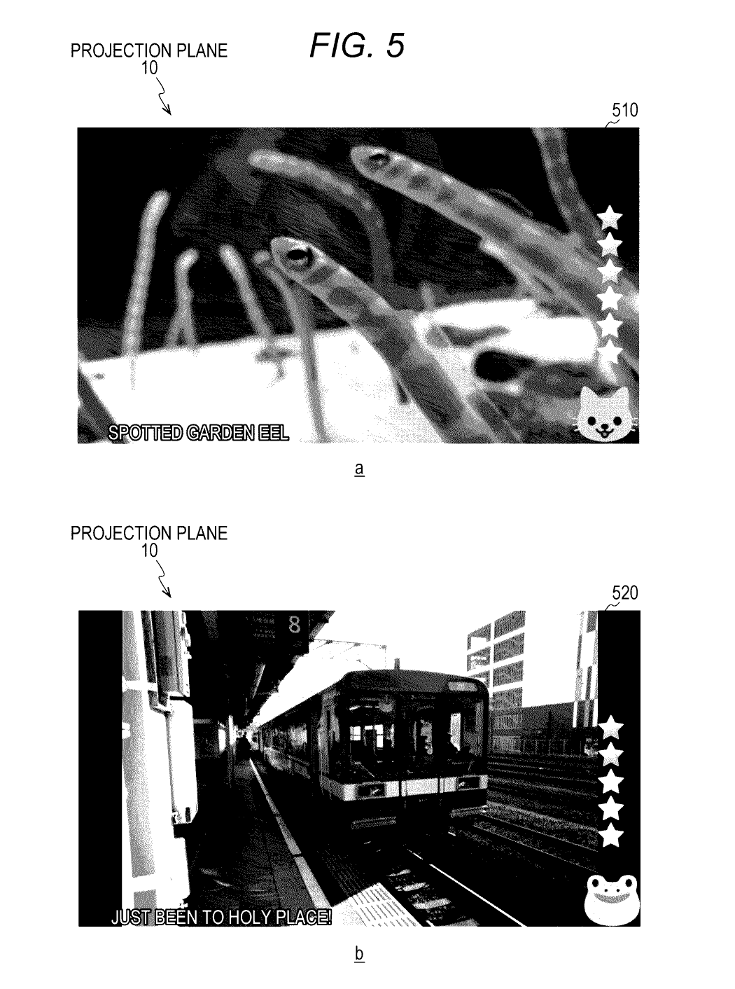

The user performs an upward flick operation in the operation area 563 of the operation screen 560 in a state in which a content for which the user wants to add points is displayed on the projection plane 10. When the upward flick operation is performed in the operation area 563, a star mark is displayed on the right of the projected image displayed on the projected image 550. Note that, if a star mark is already displayed, the number of displayed stars is increased. Thus, points are added to an evaluation score of the content displayed on the projected image 550. For example, a of FIG. 5 illustrates an example of a case where an evaluation score of 6 is given to a content. In addition, for example, b of FIG. 5 illustrates an example of a case where an evaluation score of 5 is given to a content. In addition, for example, FIG. 7 illustrates an example of a case where an evaluation score of 3 is given to a content.

[Example of Content Reproduction (Example of Stopping)

Now, an example of reproducing and stopping a content in a case where reproduction and stopping of a content displayed on the projection plane 10 are performed from the information processing device 300 will be described.

The user performs a tapping operation in the operation area 563 of the operation screen 560 in a state in which a video content to be reproduced is displayed on the projection plane 10. When the tapping operation is performed in the operation area 563, reproduction of the video content displayed on the projection plane 10 is started.

In addition, for stopping a video content being reproduced, the user performs a tapping operation again in the operation area 563 of the operation screen 560. When the second tapping operation is performed in the operation area 563, reproduction of the video content displayed on the projection plane 10 is stopped. Similarly, each time a tapping operation is performed subsequently, reproduction or pause is repeated.

[Example of Audio Output]

For example, in a case where a still image content or a text message is displayed on the projection plane 10, the text (such as comment or message) contained in the projected image can be output as audio (read aloud) by a user operation.

[Example of Content Output]

In a and b of FIG. 5, examples of display of contents (projected images 510 and 520) transmitted from the information processing device 300 are illustrated. FIG. 5 illustrates an example display in a case where a still image content is transmitted from the information processing device 300.

For example, an image (a still image) of a still image content (spotted garden eel) transmitted from the information processing device 300 is displayed as the projected image 510. In this case, for example, as a result of a user operation using the operation button 562, a message “spotted garden eel” transmitted from the information processing device 300 to the information processing device 200 is displayed at the lower left of the projected image 510.

In addition, in the operation area 563, star marks, the number of which corresponds to the number of information processing devices where upward flick operations are performed, are displayed at the lower right of the projected image 510.

In addition, an image (such as an icon or an avatar) transmitted from the information processing device 300 to the information processing device 200 or a preset image is displayed at the lower left of the projected image 510. For example, an image of a cat or a frog for displaying each user is displayed.

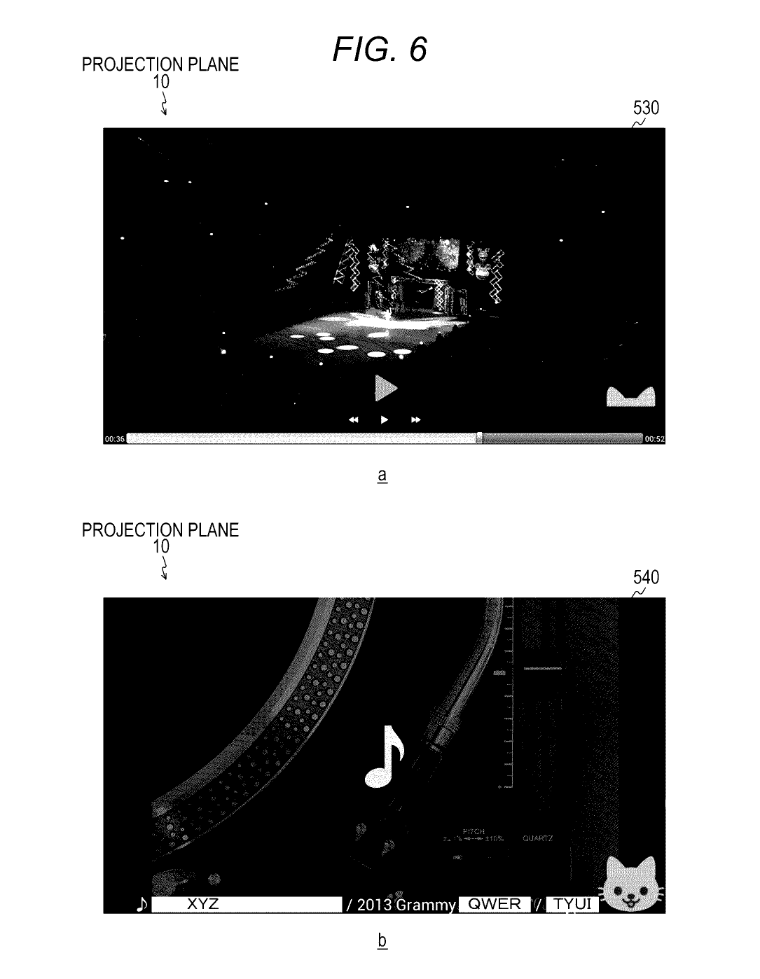

In a of FIG. 6, an example display of a content (a projected image 530) transmitted from the information processing device 300 is illustrated. In a of FIG. 6, an example display in a case where a video content is transmitted from the information processing device 300 is illustrated.

For example, an image of a video content (a representative image relating to the video, for example) transmitted from the information processing device 300 is displayed as the projected image 530. In this case, for example, as a result of a tapping operation performed in the operation area 563 of the operation screen 560, video associated with the projected image 530 can be reproduced.

In b of FIG. 6, an example display of a content (a projected image 540) transmitted from the information processing device 300 is illustrated. In b of FIG. 6, an example display in a case where a music content is transmitted from the information processing device 300 is illustrated.

For example, an image of a music content (an image relating to the music) transmitted from the information processing device 300 is displayed as the projected image 540. In this case, for example, as a result of a tapping operation performed in the operation area 563 of the operation screen 560, a music associated with the projected image 540 can be output.

FIG. 7 illustrates an example of a projected image 550 in which contents transmitted to the information processing device 200 are listed.

In the projected image 550, the thumbnail image display area 551 for listing the contents transmitted to the information processing device 200 is displayed together with an image of a content in a selected state. The image displayed in the thumbnail image display area 551 can be moved in the lateral direction by a leftward or rightward flick operation in the operation area 563 illustrated in FIG. 4. In addition, the image in the selected state can be changed by an operation of pressing a central part of the operation area 563 illustrated in FIG. 4.

Furthermore, an image displayed on the projection plane 10 can be subjected to predetermined processing in each information processing device. An example of this is illustrated in FIG. 8.

[Example of Content Processing]

FIG. 8 illustrates an example of an operation screen 570 displayed on the touch panel 301 of the information processing device 300.

On the operation screen 570, operation buttons 571 to 573, a color selection area 574, and track information 575 for operation of a projected image projected and displayed by the information processing device 200 are displayed.

For example, for an image displayed on the operation screen 570, the user can select desired colors in the color selection area 574, and draw a desired track by performing an operation of tracing over the operation screen 570. For example, the user can draw the track information 575 by tracing a heart shape with a finger over the operation screen 570. In addition, for example, the user can draw track information 576 by writing characters (Mery Xmas) with a finger over the operation screen 570.

Here, for transmitting the image on which the track information 575 is drawn (the image contained in the operation screen 570) to the information processing device 200 for display, the operation button 573 is pressed. In addition, for deleting the drawn track information 575, the user presses the operation button 572. For terminating operation for drawing track information, the operation button 571 is pressed. In this manner, a drawing function can be implemented. Furthermore, a stamping function of providing predetermined stamps on an image may be implemented.

[Example of Message Display]

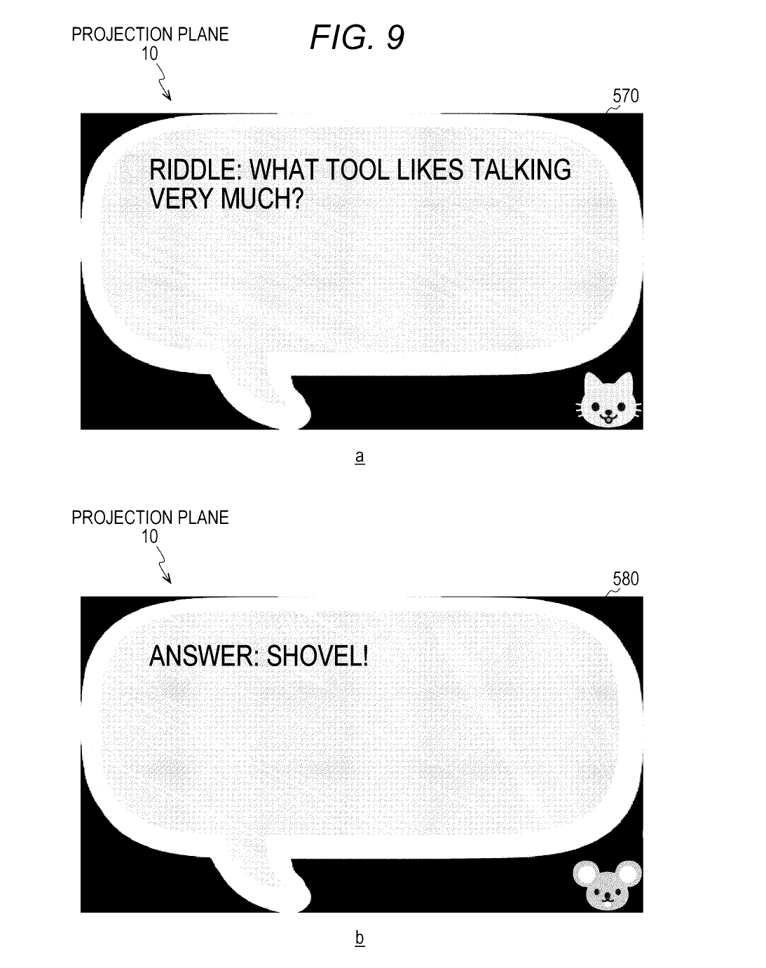

In a and b of FIG. 9, examples of display of messages transmitted from the information processing device 300 are illustrated.

In a of FIG. 9, an example display in a case where a riddle is displayed as a message transmitted from the information processing device 300 is illustrated. In addition, in b of FIG. 9, an example display in a case where an answer to the riddle is displayed as a message transmitted from another information processing device is illustrated.

[Example Communication]

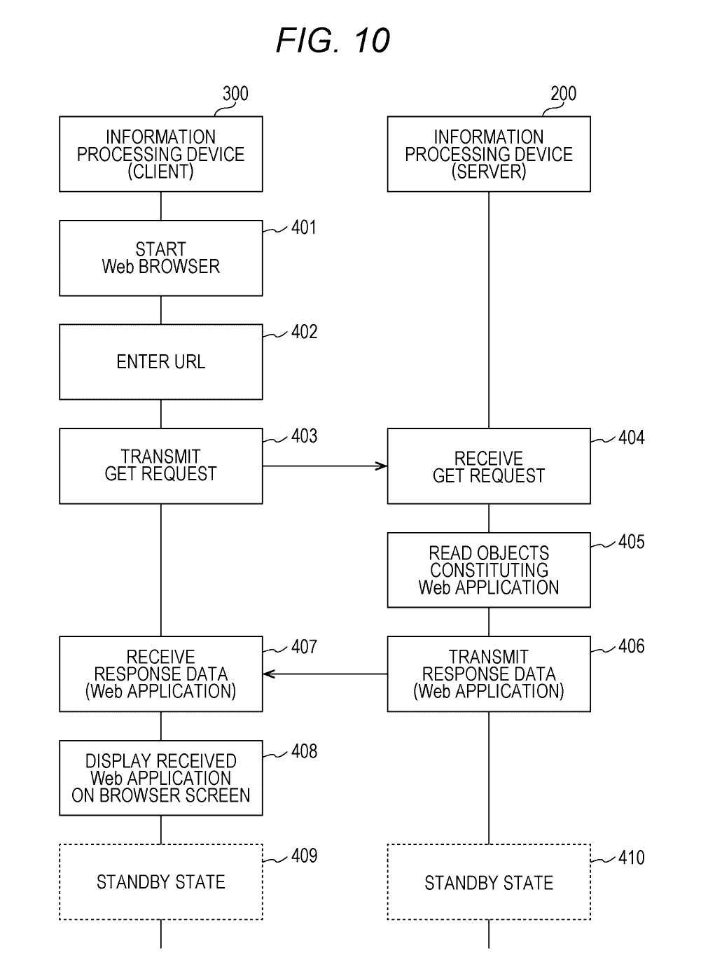

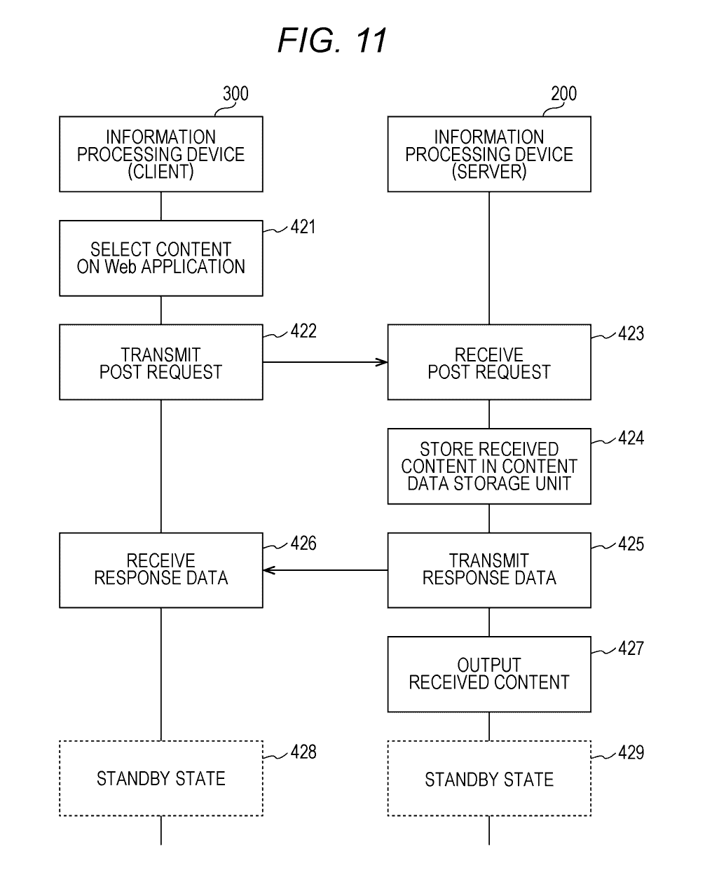

FIGS. 10 to 13 are sequence charts illustrating example communication processing between devices included in the information processing system 100 in the embodiment of the present technology. Note that, in FIGS. 10 and 11, example communication processing between the information processing device (server) 200 and the information processing device (client) 300 is illustrated.

First, in FIGS. 10 and 11, example processing procedures until a content stored in the information processing device 300 is projected by the information processing device 200 will be explained.

[Example Processing Procedures Until Web Application on Client is Started]

FIG. 10 illustrates example processing procedures until a web application on the information processing device 300 is started by the information processing device 200 connected with the information processing device 300 via a network.

First, the user starts a web browser mounted in the information processing device 300 connected with the information processing device 200 via a network (401). In this case, for example, a display screen (a projector screen, for example) projected on the projection plane 10 from the projection unit 270 of the information processing device 200 contains an URL. For example, as illustrated in FIG. 3, a projected image 500 containing an URL 501 is displayed.

The user then enters the URL indicated on the display screen using the touch panel 301 of the information processing device 300 (402). When the URL is entered in this manner, the control unit of the information processing device 300 requests application data from the web server unit 220 of the information processing device 200 (403, 404). Specifically, a GET request is transmitted from the information processing device 300 to the information processing device 200 (403, 404).

Note that a GET request is a request transmitted from a client (a web browser, for example) to a web server to request transmission of a file specified by an URL.

The web server unit 220 in receipt of the request for application data reads out application data (web application) provided in advance from the application data storage unit 230 (405). The web server unit 220 then returns the application data (web application) to the web browser on the client (information processing device 300) having transmitted the request for the application data (web application) (406, 407). Thus, response data (web application) are transmitted from the information processing device 200 to the web browser on the information processing device 300 (406, 407). Note that the process of transmitting the application data (web application) (406, 407) is an example of a first procedure stated in the claims.

The web browser on the information processing device 300 in receipt of the response data (web application) from the web server unit 220 analyzes the received response data (web application) and displays the response data on the touch panel 301 (408). In this manner, provision of an operation environment for transmitting a content to the information processing device 200 is completed (409, 410).

After the processing procedures illustrated in FIG. 10 are terminated, a state corresponding to a state in which a special application on the client connected with the server via a network is started is entered. In addition, in subsequent transmission procedures and the like, the manner in which an operation environment is provided is provision using a “web application” running on the web browser instead of a special “native application”.

[Example Processing Procedures Until Content on Client is Transmitted and Displayed]

FIG. 11 illustrates example processing procedures until a content is transmitted to the information processing device 200 connected with the information processing device 300 via a network and the content is caused to be displayed.

First, the user selects a content to be displayed by the information processing device 200 (421). For example, the user performs a selecting operation of selecting a content, which is to be displayed by the information processing device 200, on a display screen of a web application on the information processing device 300 (421). The user then performs an operation for transmitting the selected content. In response to this operation, the control unit of the information processing device 300 performs a transmission process for transmitting the selected content to the information processing device 200 (422, 423). Specifically, a POST request (content data) is transmitted from the information processing device 300 to the information processing device 200 (422, 423). Note that the process of receiving the content data (423) is an example of a second procedure stated in the claims.

Note that a POST request is a request transmitted from a client (a web browser, for example) to a web server to transmit data from the client. Note that a POST request may include information (such as an icon, an avatar, text characters, and metadata for content management) to be projected and displayed by the information processing device 200.

The web server unit 220 in receipt of the POST request (content data) stores the received content data into the content data storage unit 250 via the control unit 240 (424). The web server unit 220 then returns information indicating that reception of the content data is completed to the web browser on the client (the information processing device 300) (425, 426). Thus, response data (information indicating that reception of the content data is completed) is transmitted from the information processing device 200 to the web browser on the information processing device 300 (425, 426).

After the reception of the content data is completed, the control unit 240 of the information processing device 200 outputs the content data stored in the content data storage unit 250 through the image processing unit 260 and the audio processing unit 280 (427). For example, images based on the content are caused to be projected and displayed on the projection plane 10 by the projection unit 270 via the image processing unit 260, and audio based on the content is caused to be output by the audio output unit 290 via the audio processing unit 280 (427). Note that the process of outputting the content data (427) is an example of a third procedure stated in the claims.

[Example Processing Procedure Until Content on Server is Received and Displayed by Client]

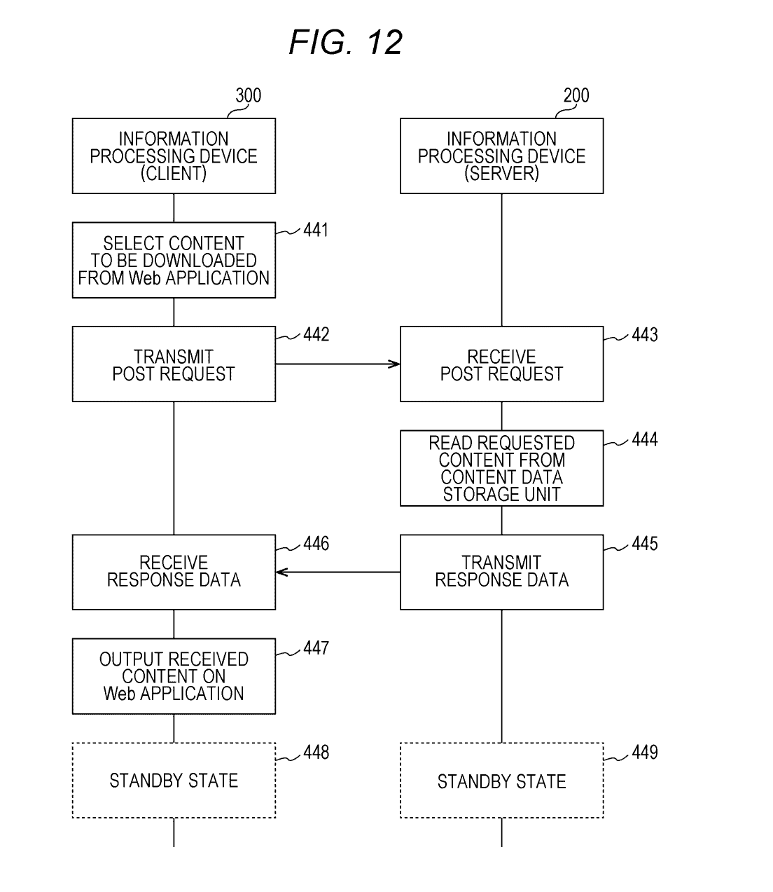

FIG. 12 illustrates example processing procedures unit a content stored in the information processing device 200 is received and displayed by the information processing device 300.

First, the user selects a content that the user wants to receive. For example, the user performs a selecting operation of selecting a content, which the user wants to receive, on a display screen of a web application on the information processing device 300 (441). For example, for selecting a content of an image displayed as a main image on the projected image, a downward flick operation is performed in the operation area 563 illustrated in FIG. 4 (441).

Alternatively, content list information for displaying a list of contents may be sequentially transmitted from the information processing device 200 to the information processing device 300, and a list of contents may be displayed on the touch panel 301 on the basis of the content list information. In this case, for example, a list of contents being presented by the information processing device 200 or having been presented by the information processing device 200 is displayed on the display screen of the web application on the information processing device 300. On this display screen, the user performs the selecting operation of selecting a content that the user wants to receive (441).

The user then performs a download requesting operation for requesting to download the selected content. Note that, when the downward flick operation in the operation area 563 illustrated in FIG. 4 is to be performed, the selecting operation and the download requesting operation can be performed at the same time. When the download requesting operation is performed, the control unit of the information processing device 300 performs a download requesting process for requesting the information processing device 200 to download the selected content (442, 443). Specifically, a POST request (a download request) is transmitted from the information processing device 300 to the information processing device 200 (442, 443).

The web server unit 220 in receipt of the POST request (the download request) reads content data associated with the request from the content data storage unit 250 via the control unit 240 (444). The web server unit 220 then returns the content data read from the content data storage unit 250 to the web browser on the client (information processing device 300) having transmitted the request (445, 446). Thus, response data (content data) are transmitted from the information processing device 200 to the web browser on the information processing device 300 (445, 446).

The web application on the information processing device 300 in receipt of the content data displays the received content on the web browser (447). Note that a received content can be stored in a storage area in the information processing device 300 as necessary on the basis of a user operation.

Note that the example in which, when a download request from the information processing device (client) is made, the information processing device 200 transmits a content associated with the request has been presented in the embodiment of the present technology. However, there are also assumed to be users who want to restrict download of contents displayed and having audio output by the information processing device 200 onto other information processing devices. For example, it is assumed that download of such contents as those offensive to public order and morals, those containing a child face, and those containing a specific location (such as a restroom) onto other information processing devices may be expected to be restricted.

Thus, download of a content can be restricted by a user setting or an automatic setting. For example, for restricting a content to other information processing devices, download restriction information is added to the content at a timing when an information processing device (client) transmits the content to the information processing device 200 (or at another timing). In this case, the information processing device 200 prohibits download of a content having download restriction information added thereto onto other information processing devices.

Furthermore, the information processing device 200 may automatically add download restriction information by using an image recognizing function or the like. For example, the control unit 240 detects whether or not a content contains a child face by using a face recognizing function (age detecting function), and adds download restriction information to the content if the content contains a child face. Thus, the control unit 240 can determine whether or not to restrict provision of each content to other information processing devices having transmitted a transmission request.

Alternatively, download may be restricted by applying various processes (such as degradation of image quality) instead of prohibiting download of a content.

[Example Processing Procedures for Operation of Server from Client]

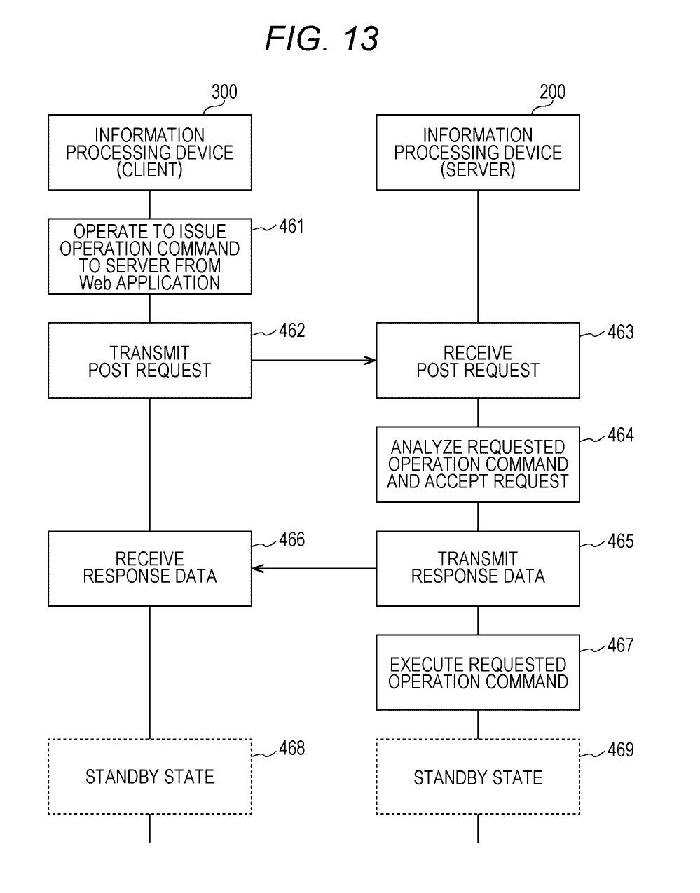

FIG. 13 illustrates example processing procedures for operating the information processing device 200 from the information processing device 300. For example, an example of a case where a remote controlling operation is performed on the information processing device 200, which is connected with the information processing device 300 via a network, by using the information processing device 300 will be presented.

First, the user (a speaker or a participant, for example) performs an issuing operation for issuing an operation command to the information processing device 200 on an operation screen of a web application on the information processing device 300 (461). When the issuing operation is performed, the control unit of the information processing device 300 performs a transmission process of transmitting the operation command to the information processing device 200 (462, 463). Specifically, a POST request (an operation command) is transmitted from the information processing device 300 to the information processing device 200 (462, 463).

The web server unit 220 in receipt of the operation command analyzes the requested operation command (464). The web server unit 220 then returns the reception of the request to the web browser on the client (the information processing device 300) having transmitted the request (465, 466).

The web server unit 220 in receipt of the operation command also outputs the analyzed operation command to the control unit 240. The control unit 240 then executes the operation command (467).

Note that a display device (such as a projector or a monitor) connected with an information processing device (a personal computer, for example) via a cable and capable of displaying a content held by the information processing device has been conventionally proposed. For example, at a meeting such as a conference, presentation can be conducted while a content held by the information processing device is displayed on the display device. In such a meeting, however, the cable connection between the information processing device and the display device needs to be switched each time a speaker is switched, which is disadvantageous in that the switching work is troublesome.

Thus, a network-enabled projector with a display device and information processing devices connected in advance by a wireless network and being thus capable of switching between information processing devices of speakers without switching the cable connection therebetween has been proposed. With the network-enabled projector, however, a special application, driver, or the like for transmitting contents using a special protocol used for data transmission between the network-enabled projector and the information processing devices is required. Thus, the speakers need to acquire the special application or the like for the information processing devices to be connected to the network-enabled projector and install the application in the information processing devices in advance.

In contrast, in the embodiment of the present technology, the need for the work of installing a special application in information processing devices (such as smart phones) is eliminated, which can significantly improve user-friendliness.

Specifically, in the embodiment of the present technology, the information processing device 200 includes the web server unit 220. Thus, it is only necessary to access the information processing device 200 from a web browser on a client terminal (the information processing device 300, for example) so as to start a web application for transmitting a content. As a result, for example, advance preparation for connecting to a network-enabled projector (installing of a special application in a terminal to be connected to the network-enabled projector) is no longer necessary.

As described above, an environment in which the information processing device 200 and a plurality of information processing devices (clients) are connected for operation can be provided. For example, even in a case where a speaker unofficially participates, a content in the information processing device of the speaker can be instantly displayed by the information processing device 200.

Furthermore, the information processing device 200 is provided with a storage (the content data storage unit 250) for saving contents transmitted from a plurality of information processing devices (clients). Thus, the saved contents can be transmitted and shared in response to requests from other information processing devices (clients) connected with the information processing device 200. In other words, a plurality of information processing devices (clients) can use the information processing device 200, to which the information processing devices (clients) are accessible, to readily share contents held by the information processing devices (clients). Furthermore, an environment in which contents can be easily shared among participants can be provided.

Furthermore, the information processing device 200 can be remotely operated in response to requests from other information processing devices (clients) connected to the information processing device 200. Thus, other information processing devices (clients) connected with the information processing device 200 can function as remote controllers for the information processing device 200. For example, participatory meetings in which contents to be displayed can be freely switched by operations of participants, in which participants grade a content of a speaker for evaluation, and so on, can be achieved.

Now, assume a case seen from a viewpoint of projector developers. For example, even when an additional function to or bug fixing of applications on information processing devices (client) is required, the applications on the users' information processing devices (clients) need not be updated individually. In addition, updating of only web application data stored in the information processing device 200 enables the web applications on the connected information processing devices (clients) to always use latest functions. Furthermore, problems of compatibility due to a difference inversion between the applications on the information processing devices (clients) and the information processing device 200 can be readily avoided.

Note that, when a projected image is displayed on the projection plane 10, a multidimensional code (a bar code for connecting to the information processing device 200, for example) may be contained in the projected image. In this case, connection can be further easily achieved by capturing the multidimensional code by an imaging unit (not illustrated) of the information processing device 300 and acquiring information (such as an URL) based on the multidimensional code.

Note that the information processing device 200 can be connected with a plurality of information processing devices and used at the same time. Furthermore, a plurality of information processing devices connected to the information processing device 200 can upload a plurality of contents on the information processing device 200 at the same time. Furthermore, a plurality of information processing devices connected to the information processing device 200 can download a plurality of contents from the information processing device 200 at the same time.

Furthermore, the information processing device 300 can download a native application from the information processing device 200 after connecting to the information processing device 200 via the web browser.

Furthermore, the information processing device 200 can display contents such as images, music, video, text messages, web pages, and contents on a cloud server.

Note that, for various contents that can be displayed by the information processing device 200, various functions can be performed. For example, content transmission, content display, content history display, content sharing (downloading), display of content transmitter icons, and the like can be performed. Furthermore, content evaluation/content grading, content slide show, prize-giving to upper-rank contents in content evaluation, and the like can be performed.

Note that, for image contents among contents that can be displayed by the information processing device 200, functions such as enlarged display, and image processing (stamping, drawing, for example) can be performed.

Furthermore, for music contents among contents that can be displayed by the information processing device 200, functions such as display of images (such as jacket images, titles, and artist names) relating to the music contents can be performed. Similarly, functions such as reproduction control (such as play, stop, and seek) can be performed.

Furthermore, for video contents among contents that can be displayed by the information processing device 200, functions such as thumbnail display, and reproduction control (such as play, stop, and seek) can be performed.

Furthermore, for text messages among contents that can be displayed by the information processing device 200, functions such as display of different background images depending on transmitters, and reading audio aloud can be performed.

As described above, according to the embodiment of the present technology, elements like those of a social networking service (SNS) can be achieved by projection onto the projection plane 10 by the information processing device 200. For example, the information processing device 200 can be used at meetings such as a party or an offline meeting in such cases where a display screen of a smart phone is to be shown to all participants, where participants are less excited or have trouble in finding conversation topics, or where some participants say, “Give us the photo!”

Furthermore, use of the information processing device 200 at such timings allows participants to actually feel unexpected joy of looking at contents brought by respective participants with all the participants, or joy of sharing contents on smart phones at events such as a drinking party or a closing party. Furthermore, the information processing device 200 can be utilized as a communication tool suitable for an offline meeting of people who interact through a network. Furthermore, the information processing device 200 can be utilized for making a reception party, a party, an offline meeting, an outdoor event, or the like successful.

Note that the embodiment described above merely presents illustrative examples for embodying the present technology, and matters in the embodiment and matters specifying the invention in the claims correspond to each other. Similarly, matters specifying the invention in the claims and matters in the embodiment of the present technology which are referred to by the same names as the matters specifying the invention correspond to each other. The present technology, however, is not limited to the embodiment, but can be embodied with various modifications made thereto without departing from the scope of the present technology.

Furthermore, the processing procedures explained in the embodiment described above may be regarded as a method including these series of procedures or may be regarded as a program for causing a computer to execute these series of procedures or a recording medium storing such a program. Examples of the recording medium that can be used include a compact disc (CD), a MiniDisc (MD), a digital versatile disc (DVD), a memory card, and a Blu-ray (registered trademark) disc.

Note that the effects mentioned herein are exemplary only and are not limiting, and other effects may also be produced.

Note that the present technology can also have the following configuration.

(1)

An information processing device including:

a web server configured to provide a content transmission environment to one or more other information processing devices connected using radio communication, and acquire a content transmitted from any of the other information processing devices where the content transmission environment has been set, the content relating to a user possessing the other information processing device; and

a control unit configured to display the acquired content.

(2)

The information processing device described in (1) above, wherein in response to a transmission request from the one or more other information processing devices, the web server provides the displayed content to the other information processing device or devices.

(3)

The information processing device described in (2) above, wherein the web server refrains from providing a content having restriction information added thereto among the displayed content to the other information processing device or devices having transmitted the transmission request.

(4)

The information processing device described in (2) above, wherein

the control unit determines whether or not to restrict provision of the displayed content to the other information processing device or devices having transmitted the transmission request, and

the web server refrains from providing a content, provision of which to the other information processing device or devices having transmitted the transmission request is determined to be restricted, to the other information processing device or devices.

(5)

The information processing device described in any one of (1) to (4) above, wherein in response to a request from any of the other information processing devices, the web server provides the content transmission environment to the other information processing device.

(6)

The information processing device described in any one of (1) to (5), further including a projection unit configured to project and display an image based on the acquired content onto a projection plane, wherein

the control unit displays the acquired content by projection onto the projection plane by the projection unit.

(7)

The information processing device described in any one of (1) to (5) above, further including a display unit configured to display an image based on the acquired content, wherein

the control unit causes the display unit to display the image based on the acquired content.

(8)

The information processing device described in any one of (1) to (7) above, wherein the control unit performs control relating to the displayed content in response to an operation request from other information processing device or devices where the content transmission environment has been set.

(9)

An information processing system including:

a first information processing device configured to transmit a setting request to a second information processing device by using radio communication, the setting request being for setting a content transmission environment for transmitting a content relating to a user possessing the first information processing device by using radio communication; and

the second information processing device including a web server configured to provide the content transmission environment to the first information processing device, and acquire a content transmitted from the first information processing device where the content transmission environment has been set, the content relating to a user possessing the first information processing device, and a control unit configured to display the acquired content.

(10)

An information processing method including:

a first procedure of providing a content transmission environment to one or more information processing devices connected using radio communication;

a second procedure of acquiring a content transmitted from any of the other information processing devices where the content transmission environment has been set, the content relating to a user possessing the other information processing device; and

a third procedure of displaying the acquired content.

(11)

An program causing a computer to execute:

a first procedure of providing a content transmission environment to one or more information processing devices connected using radio communication;

a second procedure of acquiring a content transmitted from any of the other information processing devices where the content transmission environment has been set, the content relating to a user possessing the other information processing device; and

a third procedure of displaying the acquired content.

### REFERENCE SIGNS LIST

100 Information processing system
200, 300, 310, 320, 330 Information processing device
210 Radio communication unit
220 Web server unit
230 Application data storage unit
240 Control unit
250 Content data storage unit
260 Image processing unit
270 Projection unit
280 Audio processing unit
290 Audio output unit
301 Touch panel
302 Operation receiving unit
303 Audio output unit

1. An information processing device comprising:
a web server configured to provide a content transmission environment to one or more other information processing devices connected using radio communication, and acquire a content transmitted from any of the other information processing devices where the content transmission environment has been set, the content relating to a user possessing the other information processing device; and
a control unit configured to display the acquired content.

2. The information processing device according to claim 1, wherein in response to a transmission request from the one or more other information processing devices, the web server provides the displayed content to the other information processing device or devices.

3. The information processing device according to claim 2, wherein the web server refrains from providing a content having restriction information added thereto among the displayed content to the other information processing device or devices having transmitted the transmission request.

4. The information processing device according to claim 2, wherein
the control unit determines whether or not to restrict provision of the displayed content to the other information processing device or devices having transmitted the transmission request, and
the web server refrains from providing a content, provision of which to the other information processing device or devices having transmitted the transmission request is determined to be restricted, to the other information processing device or devices.

5. The information processing device according to claim 1, wherein in response to a request from any of the other information processing devices, the web server provides the content transmission environment to the other information processing device.

6. The information processing device according to claim 1, further comprising a projection unit configured to project and display an image based on the acquired content onto a projection plane, wherein
the control unit displays the acquired content by projection onto the projection plane by the projection unit.

7. The information processing device according to claim 1, further comprising a display unit configured to display an image based on the acquired content, wherein
the control unit causes the display unit to display the image based on the acquired content.

8. The information processing device according to claim 1, wherein the control unit performs control relating to the displayed content in response to an operation request from other information processing device or devices where the content transmission environment has been set.

9. An information processing system including:
a first information processing device configured to transmit a setting request to a second information processing device by using radio communication, the setting request being for setting a content transmission environment for transmitting a content relating to a user possessing the first information processing device by using radio communication; and
the second information processing device including a web server configured to provide the content transmission environment to the first information processing device, and acquire a content transmitted from the first information processing device where the content transmission environment has been set, the content relating to a user possessing the first information processing device, and a control unit configured to display the acquired content.

10. An information processing method comprising:
a first procedure of providing a content transmission environment to one or more information processing devices connected using radio communication;
a second procedure of acquiring a content transmitted from any of the other information processing devices where the content transmission environment has been set, the content relating to a user possessing the other information processing device; and
a third procedure of displaying the acquired content.

11. An program causing a computer to execute:
a first procedure of providing a content transmission environment to one or more information processing devices connected using radio communication;
a second procedure of acquiring a content transmitted from any of the other information processing devices where the content transmission environment has been set, the content relating to a user possessing the other information processing device; and
a third procedure of displaying the acquired content.
